(19) United States
(12) Patent Application Publication
(10) Pub. No.: US 2015/0082030 A1
(43) Pub. Date: Mar. 19, 2015

(54) Security Mechanism for Video Storage System

(71) Applicants: Sheng-Fu Chang, Taichung City (TW); Hsien-Hsiu Wang, Taichung City (TW)

(72) Inventors: Sheng-Fu Chang, Taichung City (TW); Hsien-Hsiu Wang, Taichung City (TW)

(21) Appl. No.: 14/031,038

(22) Filed: Sep. 18, 2013

(51) Int. Cl. G06F 21/62; H04L 9/30; H04N 7/167

(52) U.S. Cl. CPC G06F 21/6218; H04N 7/1675; H04L 9/30
USPC 713/165

(57) ABSTRACT

A video storage system includes a security mechanism between a CVR unit and a CVR manager. The security mechanism provides public and private keys according to asymmetric cryptography. The public key is sent to the CVR manager. The CVR manager produces a plaintext of a video footage from an IP camera. The CVR manager produces and uses a random key according to symmetric cryptography to turn the plaintext of the video footage into an encrypted text, uses the public key to turn the random key into an encrypted text, and respectively sends the encrypted texts into video and key databases in the CVR unit. The encrypted texts can be received from the databases. The private key turns the encrypted text of the random key into the random key. The random key turns the encrypted text of the video footage into the plaintext.

### BACKGROUND OF INVENTION

1. Field of Invention

The present invention relates to a video storage system based on cloud computing and, more particularly, to a security mechanism for a video storage system based on cloud computing.

2. Related Prior Art

Service based on cloud computing is developing as computers and the Internet are developing. Storage based on cloud computing allows a user to store data on servers through the Internet. There is no need for a bulky centralized storage device. Moreover, the availability of the data is improved. Therefore, storage based on cloud computing is used for documents, video data and audio data on the Internet.

IP cameras are used for surveillance at intersections, schools, malls and homes, and resultant video data may be stored in a storage device via a server. Generally, a large corporate owns a large centralized storage device for storing the video data for its customers. However, it is too expensive and difficult for a small company to own a large centralized storage device in addition to the IP cameras, and the problem with the high cost of a large centralized storage device only gets worse since the demand for the capacity of the storage of the video data gets higher because the quantity of the video data increases as the IP cameras continue to produce video data.

Some IP camera manufacturers provide systems of cloud video recorders. In such a system, the IP cameras are connected to a server and storage devices via the Internet. Thus, the server manages the video data and related information such as where and when the video data are produced and stores the video data and the related information in the storage devices.

However, such systems are not used without any problem. Security of the video data, which involve privacy, is always a great concern. Hackers or designers of the systems can gain illegal access to the video data if they are not effectively protected. The protection of the video data may be done by cryptography based on AES, DES, 3DES, RC2, RC4, etc. However, the security is not tight enough so that there are many events of illegal access to the video data.

Therefore, the present invention is intended to obviate or at least alleviate the problems encountered in prior art.

### SUMMARY OF INVENTION

It is the primary objective of the present invention to provide a security mechanism for a video storage system based on cloud computing. The video storage system includes a CVR manager connected to IP cameras via the Internet and at least one CVR unit connected to the CVR manager via the Internet. Each of the IP cameras produces a plaintext file of a video footage. The CVR manager instructs the CVR unit to store the plaintext file of the video footage produced by each of the IP cameras so that a user can access to the plaintext files of the video footages.

To achieve the foregoing objective, the security mechanism includes the steps of producing a public key and a private key based on asymmetric cryptography and sending the public key into the CVR manager, receiving a data stream of the video footage from each of the IP cameras and packaging the data stream into a plaintext file of the video footage, operating the CVR manager to produce a random key and using the random key to turn the plaintext file of the video footage into an encrypted text file of the video footage, operating the CVR manager to use the public key to turn the random key into an encrypted text file of the random key, sending the encrypted text file of the video footage into a video database in the CVR unit and the encrypted text file of the random key into a key database in the CVR unit, receiving the encrypted text file of the random key from the key database in the CVR unit and using the private key to turn the encrypted text file of the random key into the random key; and receiving the encrypted text file of the video footage from the video database in the CVR unit and using the random key to turn the encrypted text file of the video footage into the plaintext file of the video footage. Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a block diagram of a security mechanism for a video storage system based on cloud computing according to the preferred embodiment of the present invention; and

FIG. 2 is a flow chart of the security mechanism shown in FIG. 1.

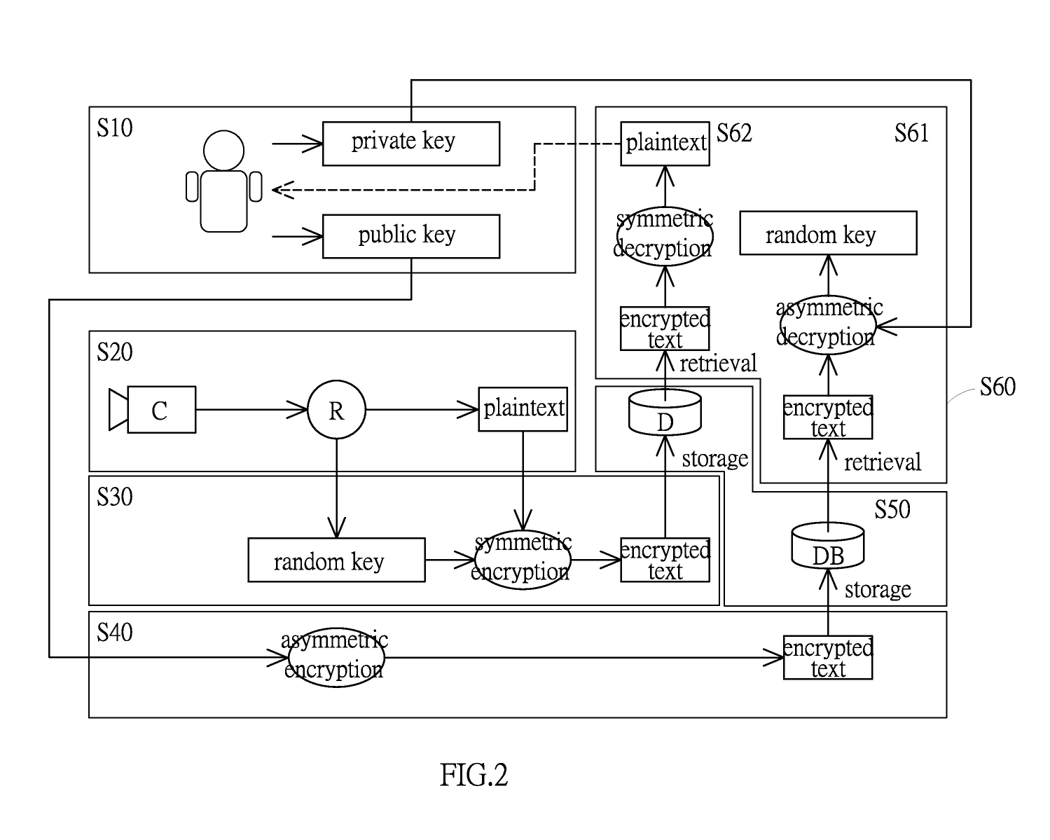

### DETAILED DESCRIPTION OF PREFERRED EMBODIMENT

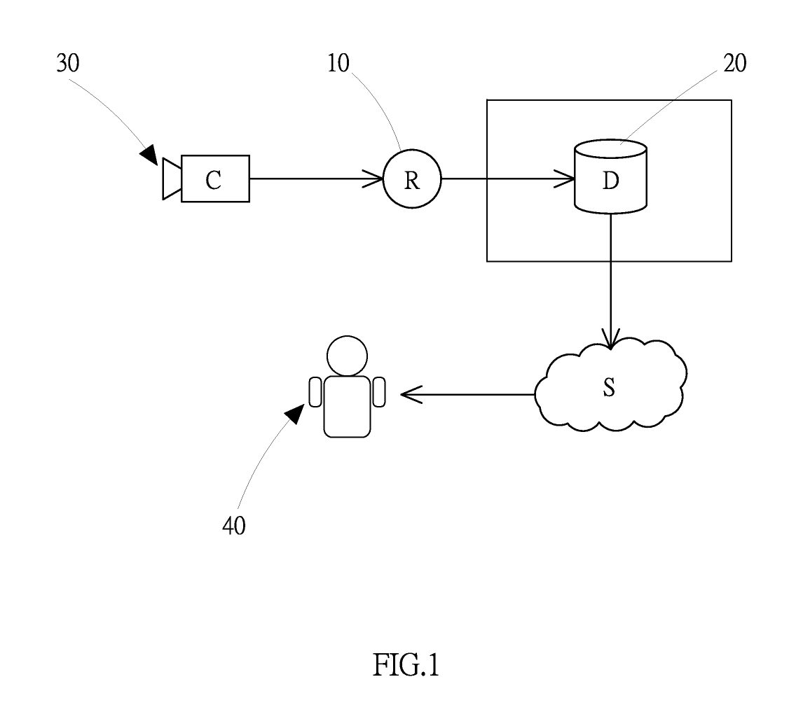

Referring to FIG. 1, there is a video storage system equipped with a security mechanism according to the preferred embodiment of the present invention. The video storage system includes a camera video recorder (“CVR”) manager 10, CVR units 20 and IP cameras 30. The CVR units 20 are connected to the CVR manager 10 via the Internet. IP cameras 30 are also connected to the CVR manager 10 via the Internet. The IP cameras 30 take video footages and accordingly produce video data. Then, the CVR manager 10 assigns the CVR units 20 to record the video data produced by the IP cameras 30. Users 40 can use various devices to access the video data produced by the IP cameras 30 and stored in the CVR units 20 via the CVR manager 10. The security mechanism is included in an intranet between the CVR manager 10 and the CVR units 20. A user 40 can access to the video data via the Internet. The security mechanism will be described.

At S10, the user 40 produces a public key and a private key based on asymmetric (or “public”) cryptography. The public key is sent to the CVR manager 10 via the Internet while the private key is kept by the user 40.

At S20, the CVR manager 10 receives a data stream of a video footage from one of the IP cameras 30. The CVR manager 10 packages the data stream into a plaintext file of the video footage such as an AVI file.

At S30, the CVR manager 10 produces a random key based on symmetric cryptography. The CVR manager 10 uses the random key to encrypt the plaintext file of the video footage and therefore produces an encrypted text file of the video footage.

At S40, the CVR manager 10 uses the public key to encrypt the random key and therefore produces an encrypted text file of the random key.

At S50, the CVR manager 10 sends the encrypted text file of the random key into a key database in at least one of the CVR units 20. Moreover, the CVR manager 10 sends the encrypted text file of the video footage into a video database in the same CVR unit 20.

At S60, the user 40 can access to the video footage. At S61, the user 40 receives the encrypted text file of the random key from the key database. The user 40 then uses the private key to decrypt the encrypted text file of the random key and therefore obtains the random key.

At S62, the user 40 receives the encrypted text file of the video footage from the video database. Then, the user 40 uses the random key to decrypt the encrypted text file of the video footage and therefore obtains the plaintext file of the video footage.

As discussed above, an excellent security mechanism is provided for the video storage system. Advantageously, the random key is used to turn the plaintext file of the video footage into the encrypted text file of the video footage. The public key is used to turn the random key into the encrypted text file of the random key. Then, the encrypted text file of the video footage and the encrypted text file of the random key are transmitted separately. After receiving the encrypted text file of the video footage, the user 40 uses the private key to turn the encrypted text file of the random key into the random key. Then, the user 40 uses the random key to turn the encrypted text file of the video footage into the plaintext file of the video footage. Hence, the security mechanism provides tight security for the video storage system.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A video storage system including a CVR manager connected to IP cameras via the Internet and at least one CVR unit connected to the CVR manager via the Internet, wherein each of the IP cameras produces a plaintext file of a video footage, wherein the CVR manager instructs the CVR unit to store the plaintext file of the video footage produced by each of the IP cameras so that a user can access to the plaintext files of the video footages, wherein the CVR manager includes a security process including the steps of:
producing a public key and a private key based on asymmetric cryptography and sending the public key into the CVR manager;
receiving a data stream of the video footage from each of the IP cameras and packaging the data stream into a plaintext file of the video footage;
operating the CVR manager to produce a random key and using the random key to turn the plaintext file of the video footage into an encrypted text file of the video footage;
operating the CVR manager to use the public key to turn the random key into an encrypted text file of the random key;
sending the encrypted text file of the video footage into a video database in the CVR unit and the encrypted text file of the random key into a key database in the CVR unit;
receiving the encrypted text file of the random key from the key database in the CVR unit and using the private key to turn the encrypted text file of the random key into the random key; and
receiving the encrypted text file of the video footage from the video database in the CVR unit and using the random key to turn the encrypted text file of the video footage into the plaintext file of the video footage.
